(19) United States
(12) Patent Application Publication
(10) Pub. No.: US 2003/0218596 A1
(43) Pub. Date: Nov. 27, 2003

(54) System for generating large-surface digital images

(76) Inventor: Peter Eschler, Offenbach (DE)

Correspondence Address: VENABLE, BAETJER, HOWARD AND CIVILETTI, LLP, P.O. BOX 34385, WASHINGTON, DC, 20043-9998, US

(21) Appl. No.: 10/349,318

(22) Filed: Jan. 23, 2003

(30) Foreign Application Priority Data
May 24, 2002 (DE) 202 08 162.1

(51) Int. Cl. G09G 5/00

(52) U.S. Cl. 345/156

(57) ABSTRACT

The present invention relates to a system for generating large-surface digital images. The system includes having a display device for representing images on a large-surface display surface based on control signals; an input device having at least one actuating element and an actuation sensor for detecting the actuation of the actuating element; a tracking unit for determining the position and orientation of the input device relative to the display surface; and a processing unit which computes in real time a change in the image on the display surface, based on the detected signals of the tracking unit and the actuation sensor, and which actuates the display device for representation of the computed change in the image.

### CROSS-REFERENCE TO RELATED APPLICATION

This application claims the priority of German Patent Application No. 202 08 162.1 filed May 24, 2002, the disclosure of which is incorporated herein by reference.

### BACKGROUND OF THE INVENTION

The present invention relates to a system for generating large-scale digital images which are represented on a large-scale display surface by a display device based on control signals.

The generation and representation of large-surface images plays an important role in many fields of commerce. For example, large-surface images are employed in advertising and for public announcements. Artists also often need a large surface in order to create an image. The present invention provides a system for generating and, if required, storing large-surface images in digital form.

The generation and processing of digital images using digital processing methods is omnipresent in media-oriented fields of design. Commercially available drawing and painting programs enable the user to design images on the computer. The corresponding systems comprise an input device for the user and a computer for processing the signals received via the input device and for converting these signals into a corresponding image on a monitor. Such input devices include the mouse, track ball, light pen, and clip board with the respective stylus and the joy stick. These input devices are limited to covering two degrees of freedom corresponding to the two dimensions of an image. The position of the input device in a reference plane is determined via these two degrees of freedom and translated into corresponding position information in the to-be-generated image. Apart from the position, these input devices partly transmit further information via additional signal transmitters, such as for example mouse pads or the pressure exerted with the clip board stylus. In many cases, tube monitors or LCD screens are employed as display devices for the output of the created digital images. Projectors with which the image can be projected onto a large display surface are frequently used particularly in commerce.

However, with existing systems for generating digital images, the form-giving possibilities are limited by the type of image generation via existing input devices. Existing systems cannot translate the artistic expression of an artist painting on a large canvas or spraying graffiti on a wall.

### SUMMARY OF THE INVENTION

An object of the present invention is to provide a system for generating large-surface digital images which does not restrict the scope of the user's possible artistic expression in creating an image.

This and other objects are achieved by the embodiments of the present invention.

One embodiment of the invention includes a display device for representing images on a large-surface display surface based on control signals. It also includes an input device which the user can freely move in front of the display surface and is provided with at least one actuating element and one actuating sensor for detecting an operation of the actuating element. Furthermore, the system includes a tracking unit for determining the position and, if required, the orientation of the input device. Finally, the embodiment also includes a processing unit which computes in real time, based on the detected signals of the tracking unit and of the actuating sensor when actuating the actuating element, a change in the image on the display surface that a spraying device instead of an input device would generate on the display surface and actuates the display device to represent the computed change in the image.

When using this system, the user stands with the input device in front of the display surface and actuates and moves this input device as if it were a spraying device. The position of the input device relative to the display system, preferably also the spatial orientation of the input device, is continually determined and transmitted to the processing unit by means of the tracking unit. In the same manner, information concerning the actuation of the actuating element is transmitted from the input device to the processing device. The imaging effect of a spraying device is simulated in the processing unit in real time on the display surface based on the data received from the tracking unit and the actuating sensor of the input device as if the user were moving and actuating such a spraying device instead of the input device. In this case, the imaging effect corresponds to a beam spot or spray spot which would form on the display surface if using a real spraying device. The display device is actuated by the processing unit for the representation of this image effect and the changes in the image that the user immediately sees on the display surface are generated by his or her action while moving and operating the input device. Preferably, the display device is a rear projector which projects the computed change in the image from the rear onto a large-surface screen as the display surface in front of which the user is standing and moving the input device.

The processing unit, for example a computer with a corresponding software module, is preferably designed in such a manner that it simulates different colors and/or spray characteristics which the user can preselect and can change while creating the image. Spray characteristics refers in this case, in particular, to the aperture angle of the spray cone or beam, to the distribution of the spray volume inside the spray cone or spray beam and to the amount of color sprayed per unit of time depending upon the pressure on the actuating element or the actuation path of the actuating element. The available spray characteristics are preferably copies of the characteristics of a real spraying device. However, they may also be artificially generated characteristics.

The actuating sensor of the input device is preferably designed in such a manner that, in addition to determining actuation, it also determines the pressure exerted on the actuating element or the path of the actuating element when actuated. Based on the spray characteristics, the processing unit then simulates the developing image based on the detected signals.

With the present system, the user can move in front of the image surface, in the present case the display surface or the screen, as if using a real spraying device to generate a large-surface image. The user's possibilities of creative expression are not limited by the type of image acquisition or by the input device as is the case with existing systems. Rather, he or she can create the image as if he were creating it on a canvas or another medium with a real spraying device. Simple design of the input device and use of the system permits intuitive creation of large-surface digital images without the user requiring any special previous knowledge or training. This system distinctly extends the scope of interaction in creating digital images. The input device with the tracking unit and the type of image creation gives the user greater freedom in artistic expression than when using conventional digital input devices.

The system enables actively creating individuals to generate and to evaluate full scale, large-surface digital images. Moreover, its easy use and the large-surface projection for direct, full scale display makes it a very effective marketing tool. The system can be used at marketing events, fairs, but also in the entertainment industry. The system can be set up as an entertainment, amusement or recreation installation for a broad public at special exhibitions and events or in recreation or amusement parks and allows anyone to spray graffiti without causing damage.

In external shape and use, the input device is preferably a copy of a real spraying device. In an especially advantageous embodiment, the input device is a copy, in external shape and use, of a spray can like those used to create graffiti. In this case, the actuating element is a copy of a spray button which can be used like the spray button of a real spray can. This embodiment does not require that the user have any previous knowledge in handling digital image processing systems. But rather, the user easily uses the dummy spray can intuitively as an input device to spray virtually an image onto the display surface interactively by pressing the spray button.

In a preferred embodiment of the present system, the system further enables the user to digitally store the image visible on the display surface, which he or she created by operating this system, in a storage medium. In this manner, the image can be retrieved again later and represented or, for example, made directly accessible on a website if there is an internet connection. In this case, storing the image occurs preferably in a predetermined directory in the storage medium to which a webserver has access for representation of the image on a website.

Various state-of-the-art tracking systems can be employed as the tracking system in the present system. The only prerequisite is their suitability for determining the position and, if required, the orientation in three-dimensional space. Fundamentally, for example, optical marker-supported or markerless processes or ultrasound-based processes can be used to detect this position. Especially advantageous are, however, electro-magnetic tracking systems, because the user cannot disturb position detection as is the case with optical systems. In an advantageous embodiment of the present system, a tracking unit is used that is provided with an emitter for generating a defined magnetic field in the region of the display surface as well as with a tracking sensor in or at the input device for determining the strength and direction of the magnetic field. This emitter may be positioned behind a screen which is used as the display surface. The position and the orientation of the input device relative to the emitter and thus to the display surface can be determined at any time via the signals of the tracking sensor. In the simplest embodiment, the tracking system determines only the position of the input device. This suffices for simple applications, in which it is assumed that the spray cone always reaches the display surface on the shortest path from the site of the tracking sensor on or in the input device. However, in the preferred embodiment, the tracking system simultaneously determines the spatial orientation of the input device, for example in the form of a spray can or in the form of a rod-shaped input device with a dummy nozzle at the tip, in such a manner that orientation of the dummy nozzle and its position can always be determined with sufficient accuracy and the generated image effect due to actuation of the input device can be calculated therefrom.

Of course, the input device must be in contact with the processing unit during operation in order to be able to exchange signals. The same applies to the connection between the processing device and the display device. These connections may be realized either in a wireless or wired manner.

### BRIEF DESCRIPTION OF THE DRAWINGS

The present invention is described once more, by way of example, in the following using preferred embodiments with reference to the accompanying drawings.

FIG. 1 illustrates a schematic representation of an exemplary embodiment of the present invention;

FIG. 2 illustrates an exemplary embodiment of an input device according to the present invention;

FIG. 3 illustrates an exemplary embodiment of an input device according to the present invention;

FIG. 4 illustrates examples of various adjustable spray and beam characteristics;

FIG. 5a illustrates an exemplary embodiment of a connection between the input device, the processing unit and the display device;

FIG. 5b illustrates an exemplary embodiment of a connection between the input device, the processing unit and the display device;

FIG. 6 illustrates an exemplary embodiment for selecting another spray characteristic or another color.

FIG. 7 illustrates an exemplary embodiment of the arrangement of the interaction region and the reset region in front of the display surface; and

FIG. 8 shows on a screen an example of an image generated with the present system.

### DETAILED DESCRIPTION OF THE INVENTION

FIG. 1 shows by way of example an overall view of the present system for interactively generating large-surface digital images. In this example, a dummy spray can, hereinafter referred to in brief as spray can, is employed as the input device 1. This spray can is coupled to a tracking system which enables determining the position and the location of spray can 1 in space relative to the display surface 8. Thus, in connection with this tracking unit a 6 DOF (degrees of freedom) input device is provided. The present system is particularly suited for large-surface display surfaces commencing with dimensions from approximately 1.2×1.2 m. In this example, a screen with a width of 3.20 m and a height of 2 m was selected as the display surface. Of course, creation of an image can also be realized on a display surface with the size of a commercial computer monitor.

In the present embodiment, the tracking unit is composed of an emitter 4, indicated by broken lines, and a tracking sensor 5. The emitter 4 is erected at a defined distance behind the screen 8 representing the display surface. The tracking sensor 5 is disposed inside the dummy spray can 1. It determines the strength and direction of the magnetic field present at its site. From the signal of this tracking sensor 5, the position of the spray button 2 and the orientation of the spray can 1 relative to the screen 8 can be determined if the position of the emitter 4 relative to the screen 8 and if the arrangement of the tracking sensor 5 inside the spray can 1 are known.

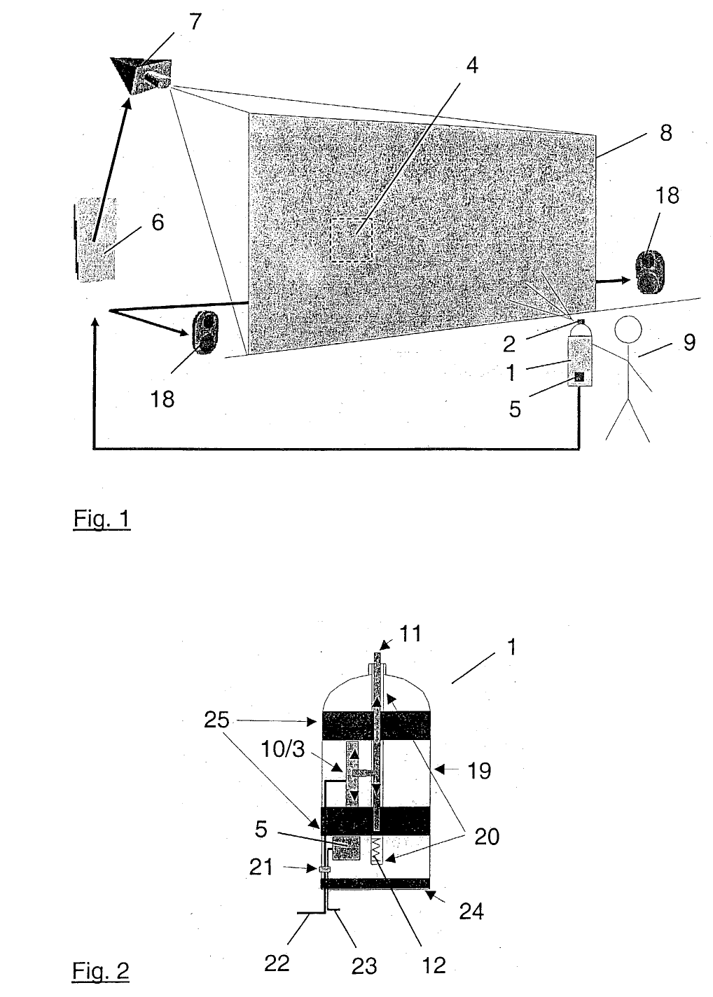

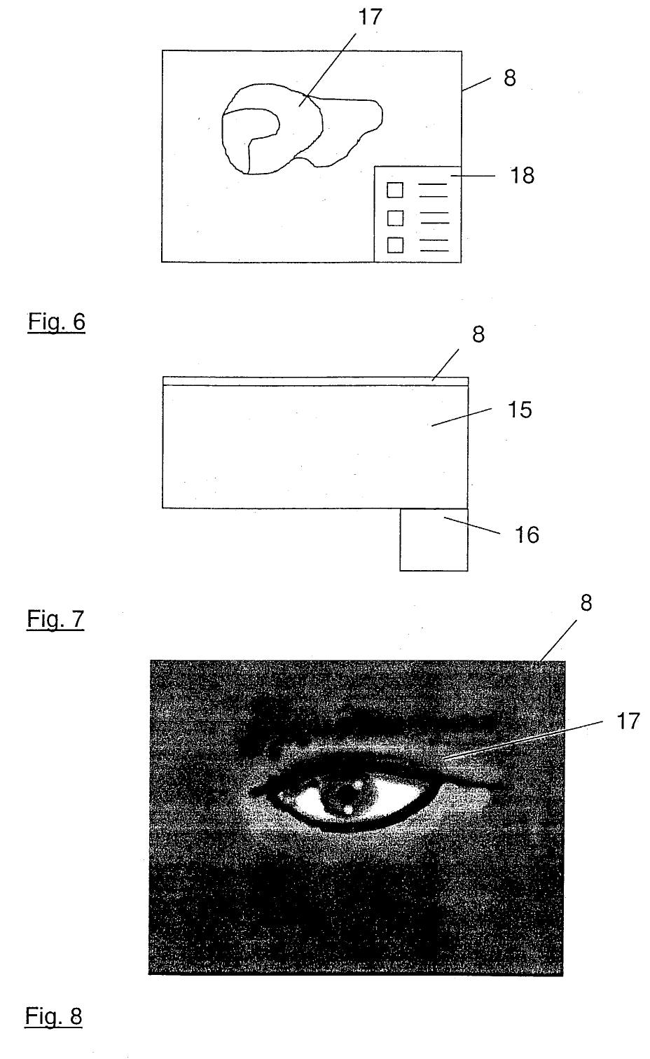

The user 9 takes this spray can 1 and stands in front of the screen 8. By pressing the spray button 2, he can generate an image on screen 8 as if he were using a real spray can. The actuation of the spray button 2 by the user 9 determined by an actuation sensor 3, as shown in FIG. 2, is transmitted to the processing unit 6, in this case a PC with corresponding system software, along with the data gathered by the tracking sensor 5. The system software simulates imaging of a spray spot at the respective site on the screen 8 using the transmitted data and taking into consideration a predetermined color and spray characteristic. The user 9 sees the image, which he generated by moving the spray can 1 and by actuating the spray button 2, directly on the wall 8 onto which he sprays virtually. The effect of moving the spray can 1 and of actuating the spray button 2 is simulated in such a manner that the user has the impression that he is using a real spray can. When the user 9 steps back from the screen 8, various selectable spray nozzles corresponding to the selection possibilities for setting the color or the spray behavior appear on the screen from which he can make a new selection. Such type possible selection is indicated in FIG. 6, which depicts a partially finished image 17 and the selection menu 18 shown on the screen 8. The selection of the individual options from the selection menu 18 may occur by means of corresponding moving of the input device and pressing the spray button.

In the same manner, referring now to FIG. 7, by positioning the spray can in a predetermined region 16 outside the interaction region 15 before the screen 8 and briefly pressing the spray button 2, the finished image can be stored in the processing unit 6 and the screen can be cleared so that the process can start anew. FIG. 7 shows by way of example the interaction region 15 in front of the screen 8 in which image creation occurs and a reset region 16 outside this interaction region in which a press of the spray button 2 leads to the storage and clearing step.

In the present embodiment, the image calculated by the system software and/or the change in the image calculated in real time is projected from the rear onto the screen 8 via a rear projector 7. In addition, FIG. 1 shows loudspeakers 18 with which the action of creating the image can be accompanied by suited noise effects (e.g. hissing noise of the can or clacking when shaking the can) as well as music.

FIG. 2 shows an example of a schematic diagram of the setup of a dummy spray can 1 as the interaction device in the present system. The housing 19 has the shape of a spray can from which a moveable rod 11 extends which is guided inside the housing 19 via a guide rail 20. The rod 11 is connected to the spray button 2, not depicted in this figure, in such a manner that when the spray button is pressed, the rod 11 moves into the housing 19. An elastic reset element 12 which counteracts the movement of the rod 11 into the housing 19 is provided at the other end of the moveable rod 11. If the user releases the spray button, the rod 11 returns to its original position due to the reset force. The rod 11 is coupled to a potentiometer 10 which is moved when the rod 11 moves. By scanning this potentiometer 10, each position of rod 11 and therefore the pressing on the spray button 2 can be determined along the path of the movement of rod 11. In this manner, a further analogue input value for the processing unit 6 can be determined in addition to the position and the orientation. This analogue input value can be used to simulate different spray effects. In addition, the tracking sensor 5 by which the position and the orientation of the can 1 can be detected, is disposed in the housing 19 of this dummy spray can 1. The tracking sensor 5 and the potentiometer 10 acting as the actuating sensor 3 are connected to the processing unit 6 via corresponding cables 22, 23. The housing 19 is equipped with stabilizers 25 and a rigid floor 24 for increased stability. Furthermore, a strain relief 21 is provided for the two cables 22, 23.

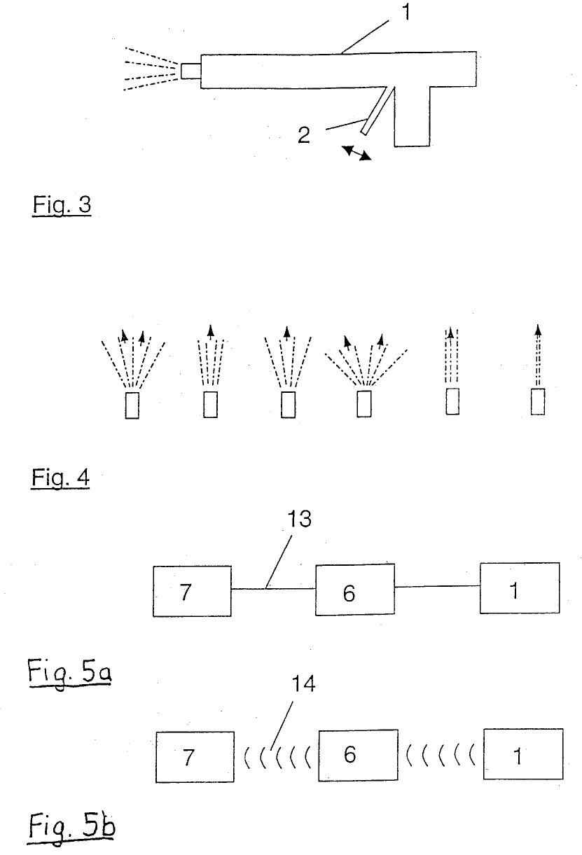

FIG. 3 shows in a schematic diagram a further example of an input device 1 whose operation is copied from a spraying device. In this embodiment, an actuating unit is also provided in the form of a moveable handle 2. The (virtual) beam emits from a site on this input device 1. This site from which the beam emits is at a distance from the actuating element 2.

FIG. 4 shows examples of various spray respectively beam characteristics which can be set with the processing unit 6. Thus various spray characteristics with different spray angles can be realized. Simulation of compact beams (opening angle of 0°) with various beam diameters is also possible.

FIGS. 5a and 5b show various possible ways of connecting the single components of the present system. For example, in FIG. 5a, the processing unit 6 can be connected to the input device 1 and the display device 7 via cable 13. In FIG. 5b, the processing unit 6 can be connected to the input device 1 and the display device 7 via a radio link 14 for exchanging data signals.

Finally FIG. 8 shows an example of an image 17 sprayed onto screen 8 using the present system.

The presented system combines existing production technology, a newly developed dummy spray can for input and a newly developed software which determines the position of the dummy spray can in the 3D space in front of a screen using tracking technology and simulates an environment that enables the user to paint images on a wall by means of virtual spraying with a dummy spray can. The scope of possibilities of artistic expression is substantially increased thereby and enables intuitive creation of large-surface digital images without requiring special previous knowledge of the user.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A system for creating large-surface digital images, comprising:
a display device for representation of images on a large surface display surface based on control signals;
an input device adapted to be moved by a user freely in front of the display surface and including at least one actuating element and an actuation sensor for detecting an actuation of the actuating element;
a tracking unit for determining at least one of the position and the orientation of the input device relative to the display surface; and
a processing unit operative to compute in real time a change in an image on the display surface as if the input device were a spraying device, based on detected signals of the tracking unit and of the actuation sensor upon actuation of the actuating element, and to actuate the display device for representation of the computed change in the image.

2. A system according to claim 1, wherein the actuation sensor detects one of the pressure exerted by the user on the actuating element and an actuation path of the actuation element.

3. A system according to claim 2, wherein the actuation sensor is a potentiometer via which a movement of a rod attached to the actuating element caused by actuation of the actuating element is detectable, the rod being connected to an elastic reset element for counteracting movement of the rod.

4. A system according to claim 2, wherein the processing unit simulates one of various beam strengths and spray strengths of a spraying device depending upon one of the pressure exerted by the user on the actuating element and the actuation path of the actuating element.

5. A system according to claim 1, wherein the processing unit is designed to simulate at least one of various colors, beam characteristics, and spray characteristics of a spraying device, the colors, beam characteristics, and spray characteristics being selectable by the user.

6. A system according to claim 1, wherein the display device is a rear projector that represents the computed change in the image, and wherein a screen is the display surface.

7. A system according to claim 1, wherein the tracking unit further comprises:
an emitter for generating a defined magnetic field; and
a tracking sensor disposed one of in and on the input device for determining the strength and direction of the magnetic field.

8. A system according to claim 1, wherein the tracking unit uses an optical tracking process for determining at least one of the position and the orientation of the input device.

9. A system according to claim 1, wherein the tracking unit uses an ultrasonic tracking process for determining at least one of the position and the orientation of the input device.

10. A system according to claim 1, wherein the processing unit and the input device are connectable via a cable for transmission of the detected signals.

11. A system according to claim 1, wherein the processing unit and the input device communicate via a radio link for transmission of the detected signals.

12. A system according to claim 1, wherein the processing unit is provided with a function, adapted to be activated by the user, for storing in digital form in a storage medium an image momentarily represented by means of the display device on the display surface.

13. A system according to claim 12, wherein the processing unit stores the image in a predetermined directory to which a Web server has access for representation of the image on a Web site.

14. A system for creating large-surface digital images, comprising:
a display device for representation of images on a large-surface display surface based on control signals;
an input device for simulating the exterior shape and operation of a spraying device, the input device being adapted to be moved by a user freely in front of the display surface and including at least one actuating element and an actuation sensor for detecting an actuation of the actuating element,
a tracking unit for determining at least one of the position and the orientation of the input device relative to the display surface; and
a processing unit operative to compute in real time a change in an image on the display surface as if the input device were a spraying device, based on detected signals of the tracking unit and the actuation sensor upon actuation of the actuating element, and to actuate the display device for representation of the computed change in the image.

15. A system according to claim 14, wherein the actuation sensor detects one of a pressure exerted by the user on the actuating element and an actuation path of the actuating element.

16. A system according to claim 15, wherein the actuation sensor is a potentiometer via which a movement of a rod attached to the actuating element caused by actuation of the actuating element is detectable, the rod being connected to an elastic reset element for counteracting movement of the rod.

17. A system according to claim 15, wherein the processing unit simulates one of various beam strengths and spray strengths of the spraying device depending upon one of the pressure exerted by the user on the actuating element and the actuation path of the actuating element.

18. A system according to claim 14, wherein the processing unit is designed to simulate at least one of various colors, beam characteristics, and spray characteristics of the spraying device, the colors, beam characteristics, and spray characteristics being selectable by the user.

19. A system according to claim 14, wherein the display device is a rear projector that represents the computed change in the image, and wherein a screen is the display surface.

20. A system according to claim 14, wherein the processing unit is provided with a function, adapted to be activated by the user, for storing in digital form in a storage medium an image momentarily represented by means of the display device on the display surface.

21. A system according to claim 20, wherein the processing unit stores the image in a predetermined directory to which a Web server has access for representation of the image on a Web site.
